(19) United States
(12) Patent Application Publication
(10) Pub. No.: US 2002/0064244 A1
(43) Pub. Date: May 30, 2002

(54) Phase noise tracker with a delayed rotator

(75) Inventors: Magnus H. Berggren, San Diego, CA (US); Pranesh Sinha, San Diego, CA (US)

Correspondence Address: LYON & LYON LLP, 633 WEST FIFTH STREET, SUITE 4700, LOS ANGELES, CA, 90071, US

(73) Assignee: Conexant Systems, Inc.

(21) Appl. No.: 09/728,351

(22) Filed: Nov. 30, 2000

(51) Int. Cl. H04L 25/08

(52) U.S. Cl. 375/346

(57) ABSTRACT

An improved phase noise tracker comprising a first rotator, delayed second rotator and feedback loop coupled to the first and second rotators. The feedback loop further comprises a phase error detector and low-pass filter. The phase error detector estimates a phase error value of the first rotator's output, and the low-pass filter smooths out the output of the phase error detector by accumulating previous estimated phase error values from the phase error detector. The output of the feedback loop, from the low-pass filter's output, is fedback to a phase control input of the first rotator to control the phase rotation of the first rotator. The feedback loop's output is fed to a phase control input of the delayed second rotator to control its phase rotation. Therefore, the improved phase noise tracker tracks phase noise based on both previous and future phase error values, which more accurately corrects for phase noise.

### BACKGROUND OF THE INVENTION

1. Field of the Invention

This invention relates to the correction of phase noise in a system and, more particularly, to a phase noise tracker for correcting phase noise using a delayed rotator.

2. Related Art

A trellis-coded 8-VSB (Vestigial Sideband) signal format is a standard for terrestrial DTV (Digital TV) broadcasting that was approved by the ATSC (Advanced Television Systems Committee) in 1995. The 8-VSB signal format has 8 discrete data levels and is segmented into symbols, which are transmitted at a rate of about 10 mega-symbols per second.

DTV receivers typically include several local oscillators. The local oscillators are used to generate sinusoidal signals to down-convert the frequency of an incoming DTV signal. Unfortunately, practical local oscillators do not produce a pure sinusoid but rather smeared sinusoidal signals that introduce phase noise into the DTV signal. Uncompensated phase noise can lead to long bursts of errors in a DTV trellis decoder, which substantially degrade the performance of the decoder. As a result, DTV receivers typically employ a phase noise tracker to correct for the phase noise.

FIG. 1 shows a typical phase noise tracker 3 coupled to a Hilbert filter 7. The Hilbert filter 7 enables the phase tracker 3 to track the phase noise of an incoming 8-VSB signal. The Hilbert filter 7 has an input 5 for receiving an incoming 8-VSB signal and a complex output 10a and 10b, as understood by those of skill in the art and explained briefly below. The phase tracker 3 comprises a complex rotator 15 and a feedback loop 20. The complex rotator 15 has a complex input coupled to the output 10a and 10b of the Hilbert filter 7, a phase control input 17 and a complex output 19a and 19b. The output of the phase tracker 3 is taken at the output 19a and 19b of the rotator 15. The feedback loop 20 has a complex input coupled to the output 19a and 19b of the rotator 15 and an output 45 coupled to the phase control input 17 of the rotator 15. The feedback loop 20 further comprises a phase error detector 30 and a low-pass filter 40. The phase error detector 30 has a complex input coupled to the output 19a and 19b of the rotator 15 and an output 35. The low-pass filter 40 has an input coupled to the output 35 of the phase error detector 30 and an output 45 coupled to the phase control input 17 of the rotator 15.

The Hilbert filter 7 is used to transform an incoming input 8-VSB signal at its input 5 into a complex signal having an I (in-phase) component 10a and a Q (quadrature) component 10b. The complex signal 10a and 10b is sent to the rotator 15 of the phase tracker 3. The rotator 15 rotates the phase of the complex signal 10a and 10b by an amount controlled by the output 45 of the feedback loop 20, which is coupled to the phase control input 17. The phase error detector 30 of the feedback loop 20 estimates the phase error of the output 19a and 19b of the rotator 15. The phase error detector 30 then outputs an estimated phase error value on output line 35 to the low-pass filter 40. The low-pass filter 40 smoothes out the output 35 of the phase error detector 30 by accumulating previous estimated error phase values from the error phase detector 30. Thus, the output 45 of the low-pass filter 40 is based on previous estimated phase error values and slowly tracks changes in the estimated phase error value. The output 45 of the low-pass filter 40 is feed back to the rotator 15 at its phase control input 17. This causes the rotator 15 to rotate the phase of the complex signal 10a and 10b in a direction that decreases the estimated phase error value, and thereby reduce phase noise.

The phase error caused by phase noise is typically correlated to both previous and future phase error values. A drawback of the above phase tracker 3 is that the output 45 of the feedback loop 20, which controls the phase rotation of the rotator 15, is based on previous phase error values. Therefore, there is a need for a phase noise tracker that tracks phase noise based on both previous and future phase error values. This would allow the phase noise tracker to more accurately correct for phase noise and operate under more severe phase noise conditions.

### SUMMARY

This invention provides a phase noise tracker that corrects for phase noise and can operate under severe phase noise conditions.

One embodiment of the improved phase noise tracker comprises the components of the phase tracker shown in FIG. 1 in addition to a complex delay element and a second complex rotator. The complex delay element is coupled between the Hilbert filter and the second complex rotator. The feedback loop circuit controls the phase rotation of the second rotator.

The effect of the delay element is to delay the input of the second rotator with respect to the input of the feedback loop. This causes the estimated phase error value of the feedback loop to be ahead in time compared to the delayed input of the second rotator. As a result, the output of the feedback loop is based on both previous and future estimated phase error values relative to the second rotator. Because the output of the feedback loop is used to control the phase rotation of the second rotator, the second rotator is able to track phase noise based on both previous and future estimated phase error values.

Therefore, the use of the delay and the second rotator enables the phase noise tracker to more accurately track phase noise based on both previous and future estimated phase error values. This allows the improved phase noise tracker to operate under more severe phase noise conditions than the prior art.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWING

The components in the figures are not necessarily to scale, emphasis instead being placed upon illustrating the principles of the invention. Moreover, in the figures, like reference numerals designate corresponding parts throughout the different views.

FIG. 1 illustrates a block diagram of a prior art phase tracker.

FIG. 2 is a block diagram illustrating a phase tracker.

FIG. 3 is a block diagram illustrating a Hilbert filter.

FIG. 4 illustrates an I/Q diagram used in estimating phase error.

FIG. 5 is a block diagram illustrating a low-pass filter.

FIG. 6 is a block diagram illustrating an AGC (automatic gain control) feedback loop.

### DETAILED DESCRIPTION OF THE PREFERRED EMBODIMENT

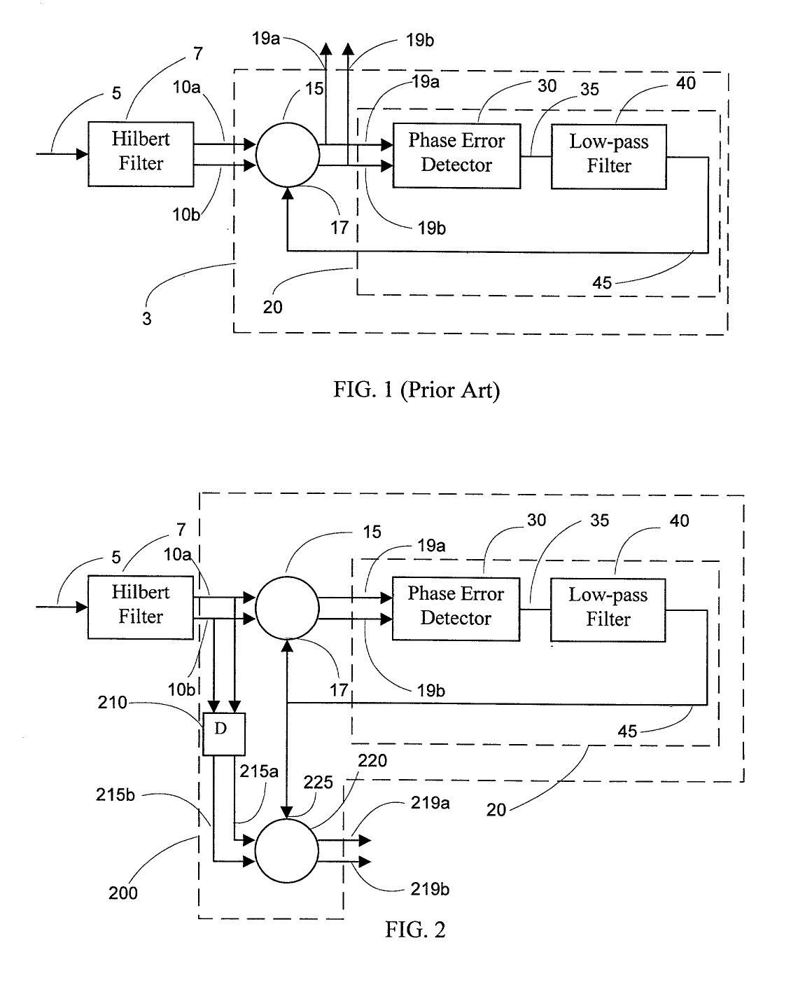

FIG. 2 illustrates a phase tracker 200 according to an example embodiment of the invention. The phase tracker 200 comprises all the components of the phase tracker 3 shown in FIG. 1. In addition, the phase tracker 200 further comprises a complex delay 210 and a second rotator 220. The complex delay 210 has a complex input coupled to the output 10a and 10b of the Hilbert filter 7 and a complex output 215a and 215b. The second complex rotator 220 has a complex input coupled to the output 215a and 215b of the delay 210, a phase control input 225 and a complex output 219a and 219b. The output of the phase tracker 200 is taken at the output 219a and 219b of the second rotator 220. The output 45 of the feedback loop 20 is coupled to the phase control input 17 of the first rotator 15 as well as the phase control input 225 of the second rotator 220. Thus, the phase rotation of the first rotator 15 and the second rotator 220 are both controlled by the same feedback loop 20.

The complex signal 19a and 19b inputted to the feedback loop 20 is ahead in time compared to the delayed input signal 215a and 215b of the second rotator 220. This causes the estimated phase error value 35 of the phase error detector 30 to also be ahead in time compared to the delayed input signal 215a and 215b of the second rotator 220. As a result, the output 45 of the feedback loop 20 is based on both previous and future estimated phase error values relative to the second rotator 220.

Because the output 45 of the feedback loop 20 is used to control the phase rotation of the second rotator 220, the second rotator 220 is able to track the phase noise of its delayed input signal 215a and 215b based on both previous and future estimated phase error values. As a result, the improved phase tracker 200 more accurately tracks phase noise than the phase noise tracker of the prior art. This allows the improved phase tracker 200 to operate in more severe noise conditions. In addition, for a given amount of phase noise, the improved phase tracking leads to a lower symbol error rate (SER) and hence better performance.

The number of future estimated phase values relative to the delayed input signal 215a and 215b of the second rotator 220 is a function of the amount of delay introduced by the delay 210. The greater the delay, the greater the number of estimated phase values. The amount of delay introduced by the delay element 210 is typically given in units of taps, which correspond to one symbol of the complex signal 10a and 10b. Preferably, the delay element 210 introduces a delay of about 50 taps.

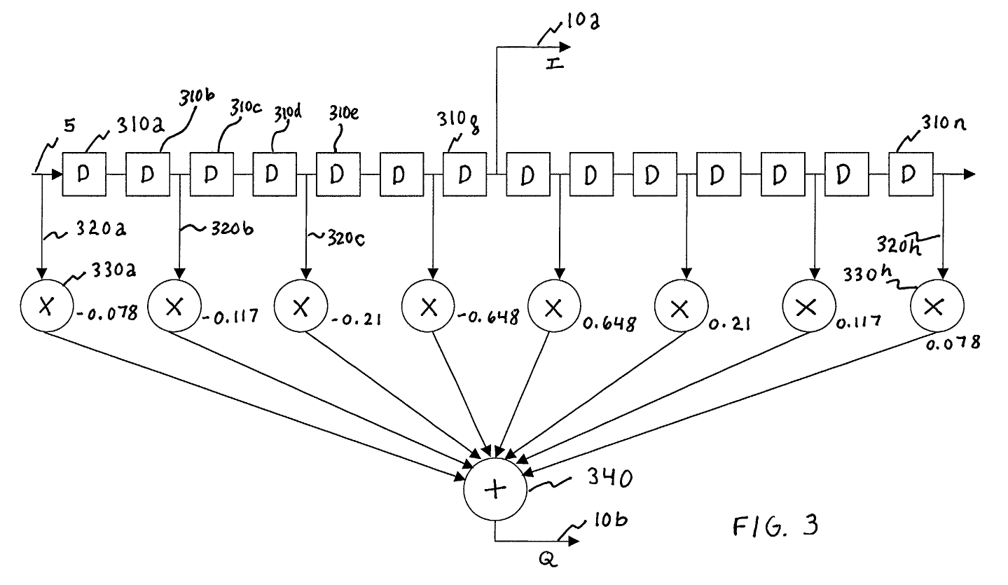

The Hilbert filter 7, the phase error detector 30 and the low-pass filter 40 according to an example embodiment of the invention will now be described in detail with reference to FIGS. 3, 4 and 5. FIG. 3 illustrates a Hilbert filter 7 built in accordance with an example embodiment of the invention. The Hilbert filter 7 comprises fourteen 1-tap delays 310a-310n coupled in series and eight branches 320a-320h, where each branch 320a-320h is taken between every other 1-tap delay 310a-310n. For example, the first branch 320a is taken at the input 5 of the first 1-tap delay 310a, the second branch 320b is taken between 1-tap delays 310b and 310c, and the third branch 320c is taken between 1-tap delays 310d and 310e. The Hilbert filter 7 also comprises eight multipliers 330a-330h, wherein each multiplier 330a-330h multiplies one of the branches 320a-320h by a coefficient. The number next to each multiplier 330a-330h in FIG. 3 indicates an example value of the coefficient of the multiplier 330a-330h. The Hilbert filter 7 further comprises an adder 340 for adding the outputs of the eight multipliers 330a-330h.

The input 8-VSB signal 5 is inputted to the first 1-tap delay 310a. In the example embodiment, the I component 10a of the Hilbert filter 7 output is taken at the output of the seventh 1-tap delay 310g. Therefore, the I component 10a is simply the input 8-VSB signal 5 delayed by 7 taps. The Q component 10b of the Hilbert filter 7 output in the example embodiment is taken at the output of the adder 340, which approximates a Hilbert transform.

The Hilbert filter 7 is used to generate a “virtual” 2-dimensional complex signal having an I component 10a and a Q component 10b from the input 8-VSB signal 5. No new information is added by generating the “virtual” 2-dimensional complex signal. However, the “virtual” complex signal allows the phase of the input 8-VSB signal 5 to be estimated in a similar manner as a normal complex signal such as a QAM (Quad-Amplitude Modulated) signal.

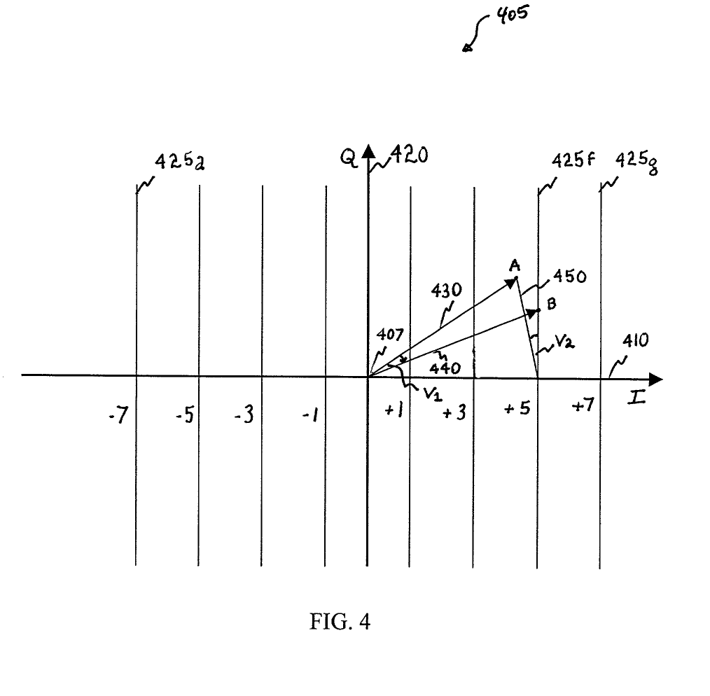

In FIG. 4, the phase error detector 30 is illustrated with an I/Q diagram 405 in which the I component is represented by a horizontal axis 410 and the Q component is represented by a vertical axis 420. Eight vertical data lines 425a-425g intersect the horizontal axis 410. Each data line 425a-425g intersects the horizontal line 410 at one of eight I component data values. For example, these eight data values may be −7, −5. −3, −1, +1, +3, +5 and +7, as shown in FIG. 4.

Point A on the I/Q diagram 405 represents one symbol of the complex signal 19a and 19b inputted to the phase error detector 30. The vertical position of point A represents the Q component 19a and the horizontal position of point A represents the I component 19b. A line 430 extending from the origin 407 of the I/Q diagram 405 to point A provides the magnitude and the phase angle of point A. The length of line 430 gives the magnitude of point A and the angle between line 430 and the horizontal line 410 gives the phase angle of point A.

To estimates the phase error of the complex signal 19a and 19b at point A, the phase error detector 20 first determines which one of the eight data values on the horizontal line 410 is closest to the I component 19b of point A. In this example case, the closest data value is +5. The phase error detector 30 then determines an angle VI needed to rotate line 430 about the origin 407 such that the end of line 430 touches or intersects the data line 425f of data value +5. Line 440 and point B represent line 430 and point A rotated clockwise by angle VI. Angle VI gives the estimated phase error value (on output line 35) of the complex signal 19a and 19b at point A. The phase error detector 30 follows a similar procedure to estimate the phase error value for each symbol of the complex signal 19a and 19b.

FIG. 4 also shows a line 450 extending from the data value +5 on the horizontal line 410 (e.g., the intersection of horizontal line 410 and data line 425f) to point A. The angle V₂ between line 450 and data line 425f can be used to approximate angle V₁ for small values of V₁. The advantage of using angle V₂ to approximate angle V₁ is that the value of V₂ is easier to calculate than V₁.

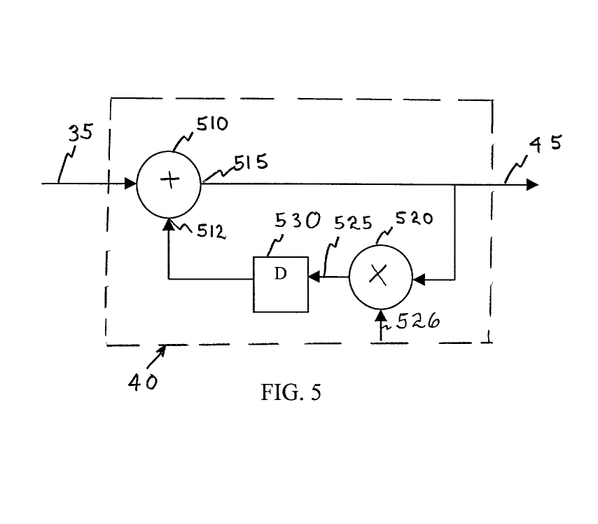

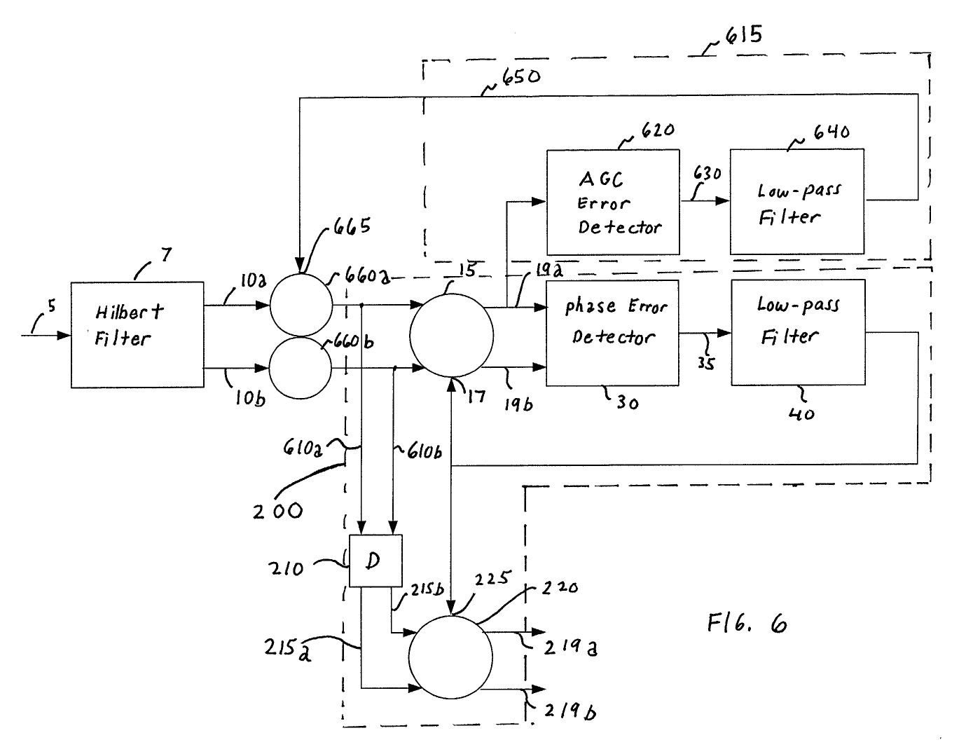

FIG. 5 illustrates a low-pass filter 40 used with an example embodiment of the invention. The low-pass filter 40 comprises an adder 510, a multiplier 520, and a delay 530. The adder 510 has a first input coupled to the output 35 of the phase error detector, a second input 512, and an output 515 coupled to the output 45 of the low-pass filter 40. The multiplier 520 has an input coupled to the output 515 of the adder 510 and an output 525. The delay element 530 has an input coupled to the output 525 of the multiplier 520 and an output coupled to the second input 512 of the adder 510.

The multiplier 520 and the delay element 530 form a feedback loop that feeds a signal proportional to the output 515 of the adder 510 back to the second input 512 of the adder 510. As a result, the adder 510 accumulates previous estimated phase error values. This enables the adder 510 to smooth out the output 35 of the phase error detector 30 based on previous estimated phase error values.

The multiplier 520 multiplies the output 512 of the adder 510 by a leaking factor 526 having a value less than 1, preferably 0.90. This is done to slowly leak off the accumulated phase error value of the low-pass filter 40. The delay 530 is used to delay the output 525 of the multiplier 520 so that it matches the arrival of estimated phase error values 35 from the phase error detector 30.

FIG. 6 shows two variable gain amplifiers 660a and 660b and an AGC (automatic gain control) feedback loop 615 coupled to the phase noise tracker 200. The two amplifiers 660a and 660b and the AGC feedback loop 615 may be used to automatically adjust the amplitude of the complex output signal 10a and 10b of the Hilbert filter 7. The gain of both amplifiers 660a and 660b are controlled by a gain control input 665. One of the amplifiers 660a has an input coupled to the I component 10a of the Hilbert filter 7 output, and the other amplifier 660b has an input coupled to the Q component 10b of the Hilbert filter 7 output. Each amplifier 660a and 660b has an output 610a and 610b, respectively, coupled to one of the complex inputs of the phase noise tracker 200. The AGC feedback loop has an input coupled to the I component 19a output of the first rotator 15 and an output 650 coupled to the gain control input 665 of the amplifiers 660a and 660b. Thus, the output 650 of the AGC feedback loop 615 controls the gain of both amplifiers 660a and 660b.

The AGC feedback loop 615 further comprises an AGC error detector 620 and a low-pass filter 640. The AGC error detector 620 has an input coupled to I component output 19a of the first rotator 15 and an output 630. The low-pass filter 640 has an input coupled to the output 630 of the AGC error detector 620 and output 650 coupled to the gain control input 665 of the amplifiers 660a and 660b.

In one example embodiment, the AGC error detector 620 compares the amplitude of the I component output 19a of the first rotator 15 to eight allowable I component data values. These eight allowable data values may, for example, be −7, −5, −3, −1, +1, +3, +5 and +7. The AGC error detector 620 determines which one of the allowable data values is closest to the amplitude of the I component output 19a of the first rotator. The AGC error detector 620 then outputs the difference between the closest allowable data value and the amplitude of the I component output 19a of the first rotator 15 as an estimated AGC error 630. The estimated AGC error 630 is inputted to the low-pass filter 640, which smoothes out the estimated AGC error 630. The lowpass filter 640 may be similar to the low-pass filter 40 used with the phase noise tracker 200. The filtered estimated AGC error 650 is then inputted to the gain control input 665 of the amplifiers 660a and 660b. This causes amplifier 660a to adjust the amplitude of the I component output 19a of the first rotator 15 in a direction that reduces the estimated AGC error 630.

While various embodiments of the application have been described, it will be apparent to those of ordinary skill in the art that many more embodiments and implementations are possible that are within the scope of the subject invention.

For example, even though the invention has been described in the context of a DTV receiver, those skilled in the art will appreciate that the invention can be implemented in a variety of systems requiring phase noise correction, especially for phase noise created by a local oscillator. Such systems include, but are not limited to, cable modems and GPS (Global Positioning Systems) receivers. In addition, those skilled in the art will appreciate that the invention can be implemented in systems using QAM (Quad-Amplitude Modulated) signals and PSK (Phase Shift Key) signals, as well as 8-VSB signals. For systems using QAM signals and PSK signals, the Hilbert filter can be omitted, since these signals are already complex signals. Therefore, the invention is not to be restricted or limited except in accordance with the following claims and their equivalents.

What is claimed is:

1. A phase noise tracker, comprising:
a first rotator comprising a signal input, a phase control input, and an output;
a feedback loop comprising an input coupled to the output of the first rotator and an output;
a delay element comprising an input coupled to the signal input of the first rotator and an output;
a second rotator comprising a signal input coupled to the output of the delay element, a phase control input, and an output; and
where the output of the feedback loop is coupled to the phase control input of the first rotator and the phase control input of the second rotator.

2. The phase noise tracker of claim 1, wherein the feedback loop further comprises a phase error detector comprising an input coupled to the output of the first rotator and an output.

3. The phase noise tracker of claim 2, wherein the feedback loop further comprises a low-pass filter comprising an input coupled to the output of the phase error detector and an output coupled to the phase control input of the first rotator and the phase control input of the second rotator.

4. The phase noise tracker of claim 3, wherein the low-pass filter further comprises: an adder comprising a first input coupled to the output of the phase error detector, a second input, and an output;
a multiplier comprising an input coupled to the output of the adder and an output; and
a second delay element comprising an input coupled to the output of the multiplier and an output coupled to the second input of the adder.

5. The phase noise tracker of claim 4, wherein the multiplier multiplies the output of the adder with a leaking factor.

6. The phase noise tracker of claim 5, wherein the leaking factor is approximately 0.90.

7. The phase noise tracker of claim 1, further comprising a Hilbert filter comprising an input and an output coupled to the signal input of the first rotator.

8. The phase noise tracker of claim 7, wherein the Hilbert filter transforms an incoming 8-VSB (Vestigial Sideband) signal at its input into a complex signal at its output, the complex signal comprising an I (in-phase) component and a Q (quadrature) component.

9. The phase noise tracker of claim 8, wherein the Hilbert filter produces the I component of the complex signal by delaying the 8-VSB signal and produces the Q component of the complex signal by approximating a Hilbert transform of the 8-VSB signal.

10. The phase noise tracker of claim 9, wherein the delay element introduces a delay of about 50 taps.

11. The phase noise tracker of claim 7, wherein the feedback loop further comprises a phase error detector comprising an input coupled to the output of the first rotator and an output.

12. The phase noise tracker of claim 11 wherein the feedback loop further comprises a lowpass filter comprising an input coupled to the output of the phase error detector and an output coupled to the phase control input of the first rotator and the phase control input of the second rotator.

13. The phase noise tracker of claim 12, wherein the low-pass filter further comprises:
an adder comprising a first input coupled to the output of the phase error detector, a second input, and an output;
a multiplier comprising an input coupled to the output of the adder, and an output; and
a second delay element comprising an input coupled to the output of the multiplier and an output coupled to the second input of the adder.

14. The phase noise tracker of claim 13, wherein the multiplier multiplies the output of the adder with a leaking factor.

15. The phase noise tracker of claim 14, wherein the leaking factor is approximately 0.90.

16. A digital TV receiver comprising the phase noise tracker of claim 1.

17. A cable modem comprising the phase noise tracker of claim 1.

18. A digital TV receiver comprising the phase noise tracker of claim 7.

19. A cable modem comprising the phase noise tracker of claim 7.

20. A method of tracking a phase noise of an input signal, comprising:
rotating the phase of the input signal;
feeding the phase rotated input signal to an input of a feedback loop;
delaying the input signal;
rotating the phase of the delayed input signal; and
controlling the steps of rotating the phase of the input signal and the phase of the delayed input signal using an output of the feedback loop.

21. The method of claim 20, further comprising transforming an incoming signal into the input signal, wherein the input signal is a complex signal comprising an I (in-phase) component and a Q (quadrature) component.

22. The method of claim 21, wherein the transforming step further comprises:
delaying the incoming signal to produce the I component of the input signal; and approximating a Hilbert transform of the incoming signal to produce the Q component of the input signal.

23. The method of claim 22, wherein the incoming signal is an 8-VSB (Vestigial Sideband) signal.

24. A method of tracking a phase noise of an input signal, comprising:
rotating the phase of the input signal;
estimating at least one phase error value for the phase rotated input signal;
feeding the at least one estimated phase error value to an input of a filter;
delaying the input signal;
rotating the phase of the delayed input signal; and
controlling the steps of rotating the phase of the input signal and the phase of the delayed input signal by using an output of the filter.

25. The method of claim 24, wherein the filter includes a low pass filter.

26. The method of claim 24, further comprising transforming an incoming signal into the input signal, wherein the input signal is a complex signal comprising an I (in-phase) component and a Q (quadrature) component.

27. The method of claim 24, wherein the transforming step further comprises:
delaying the incoming signal to produce the I component of the input signal; and approximating a Hilbert transform of the incoming signal to produce the Q component of the input signal.

28. A phase noise tracker, comprising:
first phase rotating means for rotating a phase of an input signal;
delaying means for delaying the input signal;
second phase rotating means for rotating a phase of the delayed input signal; and
controlling means for controlling the phase rotation of the first phase rotating means and the second phase rotating means based of an output of the first phase rotating means.

29. The phase tracker of claim 28, wherein the controlling means further comprises a phase error detecting means for estimating a phase error of the output of the first phase rotating means.

30. The phase tracker of claim 29, wherein the controlling means further comprises a lowpass filtering means for filtering the estimated phase error from the phase error detecting means.

31. The phase tracker of claim 28, further comprising a transforming means for transforming an incoming signal into the input signal, wherein the input signal is a complex signal comprising an I (in-phase) component and a Q (quadrature) component.

32. The phase tracker of claim 31, wherein the transforming means further comprises:
second delaying means for delaying the incoming to produce the I component of the input signal; and
Hilbert transforming means for approximating a Hilbert transform of the incoming signal to produce the Q component of the input signal.
